(19) United States
(12) Patent Application Publication
(10) Pub. No.: US 2025/0094713 A1
(43) Pub. Date: Mar. 20, 2025

(54) MULTIMODAL DATA GENERATION

(71) Applicant: BEIJING BAIDU NETCOM SCIENCE TECHNOLOGY CO., LTD., BEIJING (CN)

(72) Inventors: Shuohuan WANG, BEIJING (CN); Yekun CHAI, BEIJING (CN); Siyu DING, BEIJING (CN); Junyuan SHANG, BEIJING (CN); Zhenyu ZHANG, BEIJING (CN); Yu SUN, BEIJING (CN); Hao TIAN, BEIJING (CN); Hua WU, BEIJING (CN); Haifeng WANG, BEIJING (CN)

(73) Assignee: BEIJING BAIDU NETCOM SCIENCE TECHNOLOGY CO., LTD., BEIJING (CN)

(21) Appl. No.: 18/967,529

(22) Filed: Dec. 3, 2024

(30) Foreign Application Priority Data
Apr. 1, 2024 (CN) 202410390073X

(51) Int. Cl. G06F 40/284; G06F 16/3329

(52) U.S. Cl. CPC G06F 40/284; G06F 16/3329

(57) ABSTRACT

A multimodal data generation method is provided. The method includes: inputting a query data sequence into a multimodal model, to obtain a plurality of tokens in a response data sequence, where a current token is generated through the following operations: inputting the query data sequence and a current response data sequence into the multimodal model, so that the multimodal model generates the current token based on the query data sequence and the current response data sequence, in response to determining that the current token belongs to a first data modality; or inputting the query data sequence and a current response data sequence into the multimodal model, so that the multimodal model denoises an initial token sequence based on the query data sequence and the current response data sequence, to generate a result token sequence, in response to determining that the current token belongs to a second data modality.

### CROSS-REFERENCE TO RELATED APPLICATIONS

The present application claims priority to Chinese Patent Application No. 202410390073.X filed on Apr. 1, 2024, which is incorporated herein by reference in its entirety.

### TECHNICAL FIELD

The disclosure relates to the field of artificial intelligence technologies, in particular to the fields of technologies such as deep learning, artificial intelligence generated content (AIGC), large language models, and large multimodal models, and specifically to a multimodal data generation method, a multimodal model training method and an electronic device.

### BACKGROUND

A large language model (LLM), also referred to as a large-scale language model or a large model, is a deep learning model trained by using a large amount of text data, and can implement understanding and generation of natural language text.

A large multimodal model (LMM), also referred to as a multimodal large model, is an extension of a large language model, and can simultaneously process data of a plurality of modalities, such as text and images, to achieve cross-modal data recognition and understanding.

Methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The disclosure provides a multimodal data generation method and apparatus, a multimodal model training method and apparatus, an electronic device, a computer-readable storage medium, and a computer program product.

According to an aspect of the disclosure, there is provided a multimodal data generation method, including: obtaining a query data sequence, where the query data sequence includes at least one data segment, and where each data segment of the at least one data segment corresponds to one data modality; and inputting the query data sequence into a multimodal model, to obtain a plurality of tokens in a response data sequence output sequentially by the multimodal model, where a current token among the plurality of tokens is generated through the following operations: in response to determining that the current token belongs to a first data modality, inputting the query data sequence and a current response data sequence into the multimodal model, so that the multimodal model generates the current token based on the query data sequence and the current response data sequence, where values of unit data of the first data modality are discrete; or in response to determining that the current token belongs to a second data modality, inputting the query data sequence and the current response data sequence into the multimodal model, so that the multimodal model denoises an initial token sequence based on the query data sequence and the current response data sequence, to generate a result token sequence, where values of unit data of the second data modality are continuous, where the initial token sequence includes a preset quantity of initial tokens, and where the result token sequence includes the preset quantity of tokens starting from the current token.

According to an aspect of the disclosure, there is provided a multimodal model training method, including: obtaining a sample data sequence, where the sample data sequence includes at least one data segment, and where each data segment of the at least one data segment corresponds to one data modality; inputting the sample data sequence into a multimodal model, to obtain a plurality of tokens in a predicted data sequence output sequentially by the multimodal model, where a current token among the plurality of tokens is generated through the following steps: in response to determining that the current token belongs to a first data modality, inputting the sample data sequence and a current predicted data sequence into the multimodal model, so that the multimodal model generates the current token based on the sample data sequence and the current predicted data sequence, where values of unit data of the first data modality are discrete; or in response to determining that the current token belongs to a second data modality, inputting the sample data sequence and the current predicted data sequence into the multimodal model, so that the multimodal model denoises an initial token sequence based on the sample data sequence and the current predicted data sequence, to generate a result token sequence, where values of unit data of the second data modality are continuous, where the initial token sequence includes a preset quantity of initial tokens, and where the result token sequence includes the preset quantity of tokens starting from the current token; and adjusting a parameter of the multimodal model based on a difference between the predicted data sequence and a target data sequence corresponding to the sample data sequence.

According to an aspect of the disclosure, there is provided an electronic device, including: one or more processors; a memory storing one or more programs configured to be executed by the one or more processors, the one or more programs including instructions for: obtaining a query data sequence, where the query data sequence includes at least one data segment, and where each data segment of the at least one data segment corresponds to one data modality; and inputting the query data sequence into a multimodal model, to obtain a plurality of tokens in a response data sequence output sequentially by the multimodal model, where a current token among the plurality of tokens is generated through the following operations: in response to determining that the current token belongs to a first data modality, inputting the query data sequence and a current response data sequence into the multimodal model, so that the multimodal model generates the current token based on the query data sequence and the current response data sequence, where values of unit data of the first data modality are discrete; or in response to determining that the current token belongs to a second data modality, inputting the query data sequence and the current response data sequence into the multimodal model, so that the multimodal model denoises an initial token sequence based on the query data sequence and the current response data sequence, to generate a result token sequence, where values of unit data of the second data modality are continuous, where the initial token sequence includes a preset quantity of initial tokens, and where the result token sequence includes the preset quantity of tokens starting from the current token.

It should be understood that the content described in this section is not intended to identify critical or important features of the embodiments of the disclosure, and is not used to limit the scope of the disclosure. Other features of the disclosure will be readily understood with reference to the following description.

### BRIEF DESCRIPTION OF THE DRAWINGS

The accompanying drawings show example embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein may be implemented according to an embodiment of the disclosure;

FIG. 2 is a flowchart of a multimodal data generation method according to an embodiment of the disclosure;

FIG. 3 is a schematic diagram of a multimodal data generation process according to an embodiment of the disclosure;

FIG. 4 is a flowchart of a multimodal model training method according to an embodiment of the disclosure;

FIG. 5 is a schematic diagram of sample data sequences containing noise according to an embodiment of the disclosure;

FIG. 6 is a schematic diagram of predicted data sequences output by a multimodal model according to an embodiment of the disclosure;

FIG. 7 is a schematic diagram of a multimodal model training process according to an embodiment of the disclosure;

FIG. 8 is a schematic diagram of a mask matrix for an attention mechanism in a multimodal model according to an embodiment of the disclosure;

FIG. 9 is a schematic diagram of generating a result token sequence by a multimodal model through a plurality of reverse diffusion operations according to an embodiment of the disclosure;

FIG. 10 is a schematic diagram of sample data sequences of different modalities according to some embodiments of the disclosure;

FIG. 11 is a schematic diagram of sample data sequences of different modalities and for different tasks according to an embodiment of the disclosure;

FIG. 12 is a block diagram of a structure of a multimodal data generation apparatus according to an embodiment of the disclosure;

FIG. 13 is a block diagram of a structure of a multimodal data training apparatus according to an embodiment of the disclosure; and

FIG. 14 is a block diagram of a structure of an example electronic device that can be used to implement an embodiment of the disclosure.

### DETAILED DESCRIPTION

Example embodiments of the disclosure are described below in conjunction with the accompanying drawings, where various details of the embodiments of the disclosure are included to facilitate understanding, and should only be considered as example. Therefore, those of ordinary skill in the art should be aware that various changes and modifications may be made to the embodiments described here, without departing from the scope of the disclosure. Likewise, for clarity and conciseness, the description of well-known functions and structures is omitted in the following description.

In the disclosure, unless otherwise stated, the terms “first”, “second”, etc., used to describe various elements are not intended to limit the positional, temporal or importance relationship of these elements, but rather only to distinguish one element from the other. In some examples, a first element and a second element may refer to a same instance of the element, and in some cases, based on contextual descriptions, the first element and the second element may also refer to different instances.

The terms used in the description of the various examples in the disclosure are merely for the purpose of describing particular examples, and are not intended to be limiting. If the number of elements is not specifically defined, there may be one or more elements, unless otherwise expressly indicated in the context. Moreover, the term “and/or” used in the disclosure encompasses any of and all possible combinations of listed terms. “A plurality of” means two or more.

In the technical solutions of the disclosure, obtaining, storage, application, etc. of personal information of a user all comply with related laws and regulations and are not against the public order and good morals.

A current multimodal large model (such as GPT-4V, Flamingo, MiniGPT-4, and Gemini) typically has the multimodal data understanding capability (for example, the model can understand text and image content simultaneously), but lacks the multimodal data generation capability (for example, the model can only generate text rather than generating multimodal content such as text and images simultaneously). For a data generation task for modalities other than text (such as images and audio), a separate model usually needs to be set up additionally. For example, for an image generation task, models such as a diffusion model, a generative adversarial network (GAN), and a variational auto-encoder (VAE) may be used; and for a speech synthesis task, a specialized speech synthesis model may be used.

It can be learned from the above description that the multimodal large model in the related art only has the data generation capability of a single modality (i.e., text), but lacks the data generation capability of a plurality of modalities, which results in limited types of tasks that the multimodal large model can process, making it impossible to efficiently meet the diversified task processing needs of a user.

In view of the above problems, embodiments of the disclosure provide a multimodal data generation method based on a multimodal model, and a training method for the multimodal model.

The embodiments of the disclosure use a unified multimodal model to implement multimodal data generation. For a discrete modality such as natural language text, code, and protein sequences, the multimodal model sequentially generates each token of the modality in an autoregressive manner. For a continuous modality such as images and audio, the multimodal model performs diffusion generation by using a plurality of tokens of the modality as a whole.

The multimodal model in the embodiments of the disclosure integrates an autoregressive generation process for discrete data and a diffusion generation process for continuous data, so that the multimodal model has universal multimodal data understanding and generation capabilities, which improves the content generation effect and expands the capability range, thereby enabling the multimodal model to process diversified user tasks more flexibly and efficiently.

The embodiments of the disclosure will be described below in detail with reference to the accompanying drawings.

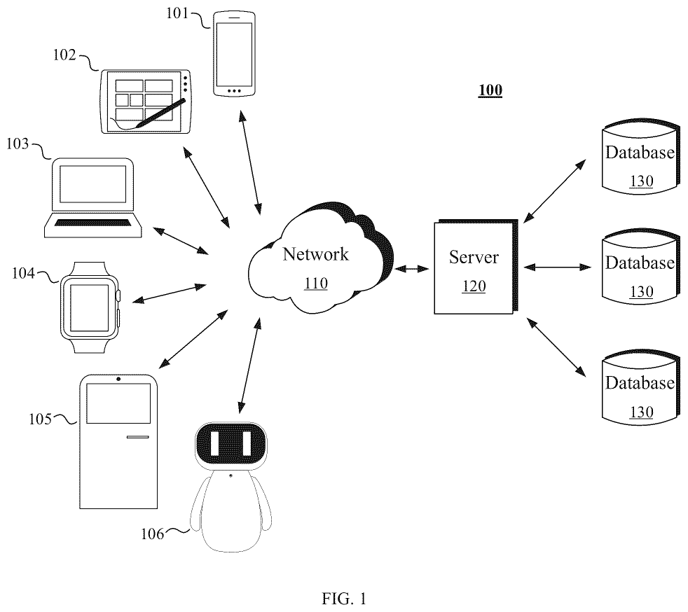

FIG. 1 is a schematic diagram of an example system 100 in which various methods and apparatuses described herein may be implemented according to an embodiment of the disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In this embodiment of the disclosure, the client devices 101, 102, 103, 104, 105, and 106, and the server 120 may run one or more services or software applications that can cause a multimodal data generation method or a multimodal model training method to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The client devices 101, 102, 103, 104, 105, and/or 106 may provide an interface that enables the user of the client device to interact with the client device. The client device may also output information to the user via the interface. Although FIG. 1 depicts only six client devices, those skilled in the art will understand that any number of client devices may be supported in the disclosure.

The client devices 101, 102, 103, 104, 105, and/or 106 may include various types of computer devices, for example, a portable handheld device, a general-purpose computer (for example, a personal computer and a laptop computer), a workstation computer, a wearable device, a smart screen device, a self-service terminal device, a service robot, a vehicle-mounted device, a gaming system, a thin client, various messaging devices, and a sensor or other sensing devices. These computer devices may run various types and versions of software application programs and operating systems, such as MICROSOFT Windows, APPLE iOS, a UNIX-like operating system, and a Linux or Linux-like operating system; or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or Wi-Fi), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and/or 106. The server 120 may further include one or more applications to display the data feeds and/or real-time events via one or more display devices of the client devices 101, 102, 103, 104, 105, and/or 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases may be used to store data and other information. For example, one or more of the databases 130 may be configured to store information such as an audio file and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the disclosure can be applied.

According to some embodiments, the server 120 may execute the multimodal model training method in the embodiments of the disclosure, to obtain a trained multimodal model. Further, the server 120 may use the trained multimodal model to execute the multimodal data generation method in the embodiments of the disclosure, to provide multimodal data generation services for the client devices 101 to 106. For example, the user may submit their data generation needs to the server 120 via the client devices 101 to 106, such as “Compose a poem about bamboo and accompany it with an image”. The server 120, by invoking the trained multimodal model, generates poetic lines themed around bamboo: “From the temple deep within the verdant bamboo grove, the faint sound of evening bells rings distant”, along with an image depicting a bamboo grove, and then returns these poetic lines and the image to client devices 101 to 106.

According to some embodiments, the server 120 may execute the multimodal model training method in the embodiments of the disclosure, to obtain a trained multimodal model. The trained multimodal model may be deployed to the client devices 101 to 106. The client devices 101 to 106 may use the locally deployed trained multimodal model to execute the multimodal model training method in the embodiments of the disclosure, to provide multimodal data generation services for the user.

According to some embodiments, the client devices 101 to 106 may alternatively execute the multimodal model training method in the embodiments of the disclosure, to obtain a trained multimodal model. This usually requires the client devices 101 to 106 to have high hardware configurations and computing capabilities.

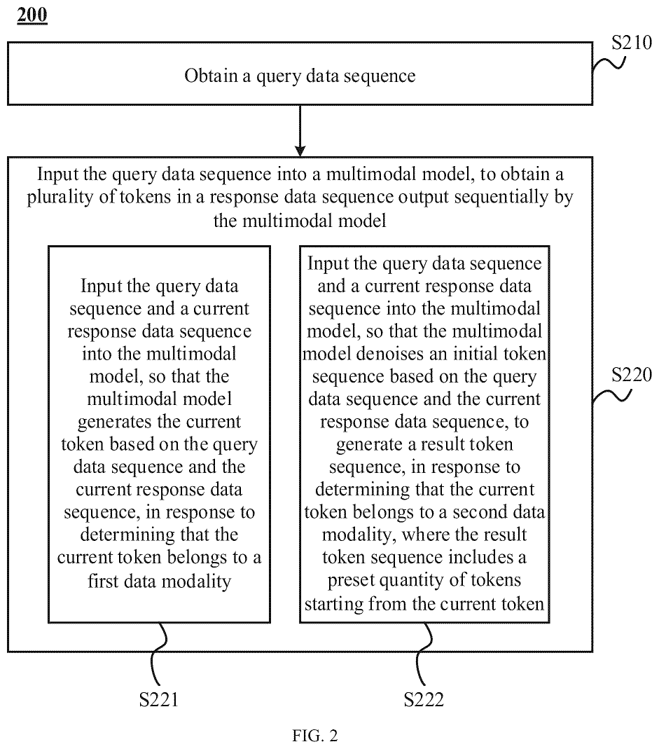

FIG. 2 is a flowchart of a multimodal data generation method 200 according to an embodiment of the disclosure. An execution body of the steps of the method 200 is usually a server, for example, the server 120 shown in FIG. 1. In some embodiments, the execution body of the method 200 may alternatively be a client device, for example, the client devices 101 to 106 shown in FIG. 1.

As shown in FIG. 2, the method 200 includes steps S210 and S220.

In step S210, a query data sequence is obtained. The query data sequence includes at least one data segment, and each of the at least one data segment corresponds to one data modality.

In step S220, the query data sequence is input into a multimodal model, to obtain a plurality of tokens in a response data sequence output sequentially by the multimodal model. A current token among the plurality of tokens is generated through the following step S221 or S222.

In step S221, the query data sequence and a current response data sequence are input into the multimodal model, so that the multimodal model generates the current token based on the query data sequence and the current response data sequence, in response to determining that the current token belongs to a first data modality. Values of unit data of the first data modality are discrete.

In step S222, the query data sequence and a current response data sequence are input into the multimodal model, so that the multimodal model denoises an initial token sequence based on the query data sequence and the current response data sequence, to generate a result token sequence, in response to determining that the current token belongs to a second data modality. Values of unit data of the second data modality are continuous. The initial token sequence includes a preset quantity of initial tokens, and the result token sequence includes the preset quantity of tokens starting from the current token.

According to the embodiments of the disclosure, a unified multimodal model is used to implement multimodal data generation. For a discrete modality such as natural language text, code, and protein sequences, the multimodal model sequentially generates each token of the modality in an autoregressive manner. For a continuous modality such as images and audio, the multimodal model performs diffusion generation by using a plurality of tokens of the modality as a whole.

The multimodal model in the embodiments of the disclosure integrates an autoregressive generation process for discrete data and a diffusion generation process for continuous data, so that the multimodal model has universal multimodal data understanding and generation capabilities, which improves the content generation effect and expands the capability range, thereby enabling the multimodal model to process diversified user tasks more flexibly and efficiently.

Data modality refers to a format or type of data, such as natural language text, tables, code, simplified molecular input line entry system (SMILES) molecular formulas, protein sequences, images, videos, audio, and point cloud data acquired by radar.

In the embodiments of the disclosure, data modalities are classified into two categories: the first data modality and the second data modality, based on whether the values of the unit data of the data modality are discrete. It should be noted that unit data of a data modality refers to basic composition units of the data of the data modality. Examples of unit data of some data modalities are shown in Table 1 below.

TABLE 1
Unit data of different data modalities

| Data modality | Unit data |
|---|---|
| Natural | Word |
| language text | |
| Table | Words that make up field |
| | names, field values, etc. |
| Code | Words that make up |
| | keywords, variable names, etc. |
| SMILES | Atom |
| molecular formula | |
| Protein sequence | Amino acid |
| Image | Pixel value of a single pixel |
| Video | Pixel value of a single pixel |
| Audio | Signal amplitude at a single |
| | moment or frequency |
| Point cloud data | Distance from a single |
| | sampling point to the radar |

In this embodiment of the disclosure, a data modality of which values of unit data are discrete is denoted as the first data modality, i.e., the values of the unit data of the first data modality are discrete. A set of values of the unit data of the first data modality may be a non-uniformly distributed finite set, i.e., a number of elements in the set of values is limited, and the distribution of the elements is not uniform.

The first data modality may be, for example, natural language text, tables, code, SMILES molecular formulas, protein sequences, and the like.

According to some embodiments, the first data modality may be divided into different granularities. For example, the data modalities such as natural language text, tables, code, SMILES molecular formulas, and protein sequences described above may each be used as a first data modality (fine granularity). For another example, natural language text and code may be collectively denoted as an “unformatted text modality”, tables are denoted as a “formatted text modality”, and SMILES molecular formulas and protein sequences are collectively denoted as a “chemical text modality” (medium granularity). For another example, since data of natural language text, tables, code, SMILES molecular formulas, and protein sequences may all be represented as a text sequence, these data modalities may be collectively denoted as a “text modality”.

In this embodiment of the disclosure, a data modality of which values of unit data are continuous is denoted as the second data modality, i.e., the values of the unit data of the second data modality are continuous. A set of values of the unit data of the second data modality may be an infinite set. For example, a distance from a sampling point to the radar may be any numerical value. The set of values of the unit data of the second data modality may alternatively be a uniformly distributed finite set, i.e., a number of elements in the set of values is limited, and the distribution of the elements is uniform. For example, for an 8-bit pixel, a value set of pixel values of a single pixel is a uniformly distributed finite set {0, 1, 2, . . . , 255}.

The second data modality may be, for example, images, videos, audio, point cloud data, and the like.

According to some embodiments, the second data modality may be divided into different granularities. For example, the second data modalities such as images, videos, audio, and point cloud data may each be used as a second data modality (fine granularity). For another example, images and videos may be collectively denoted as an “image modality”, while audio and point cloud data are each used as a separate second data modality. For still another example, since the images, videos, audio, and point cloud data described above may all be represented as images (specifically, audio data may be converted into a spectrogram, and point cloud data may be converted into a depth map), these data modalities may be collectively denoted as an “image modality”.

In step S210, a query data sequence is obtained. The query data sequence includes at least one data segment, and each data segment corresponds to the first data modality or the second data modality.

According to some embodiments, the query data sequence may be a unimodal data sequence that includes only one data segment, such as a plain text sequence, a single image, a segment of audio, etc.

According to some other embodiments, the query data sequence may be a multimodal data sequence that includes a plurality of data segments. For example, the query data sequence may be a data sequence in the form of “text-image”, “audio-text”, “text-image-text” and the like.

According to some embodiments, the query data sequence may be obtained by processing an initial query data sequence entered by the user. Specifically, the initial query data sequence may be segmented into at least one initial data segment based on data modalities. Each initial data segment corresponds to one data modality. Then, a modality tag pair indicating a data modality of each initial data segment is added to the initial data segment, to obtain the query data sequence.

According to some embodiments, the modality tag pair includes a modality data start tag and a modality data end tag that indicate a same data modality, such as a text modality tag pair <text> </text>, an image modality tag pair <img> </img>, and an audio modality tag pair <audio> </audio>.

According to some embodiments, the query data sequence may be obtained by the following steps: first, an initial query data sequence entered by the user is obtained. The initial query data sequence includes at least one initial data segment, and each of the at least one initial data segment corresponds to one data modality. Then, for each of the at least one initial data segment, a modality data start tag indicating the data modality of the initial data segment is added before the initial data segment, and a modality data end tag indicating the data modality of the initial data segment is added after the initial data segment, to obtain the query data sequence.

For example, the initial query data sequence entered by the user is “□ matches ‘There is a knight on the horse’?”, where □ represents an image specified by the user. By adding a modality tag pair to the initial query data sequence, a query data sequence “<img>□</img><text> matches ‘There is a knight on the horse’?</text>” can be obtained.

According to the above embodiment, the query data sequence may include the modality data start/end tags for indicating the data modality, thereby better guiding the multimodal model in understanding and generating multimodal data.

After the query data sequence is obtained through step S210, in step S220, the query data sequence is input into a trained multimodal model, to obtain a plurality of tokens in a response data sequence output sequentially by the multimodal model.

According to some embodiments, the multimodal model is a Transformer model that only includes a decoder. According to this embodiment, the multimodal model adopts a Decoder-Only Transformer Decoder structure, and does not include an encoder.

According to the above embodiment, the query data sequence is directly input into the multimodal model with no need to be encoded, thereby enabling the multimodal model to directly process multimodal data, which enhances the efficiency and effect of multimodal knowledge fusion, and thus improves the multimodal data understanding and generation capabilities.

According to some embodiments, a data segment of the first data modality (e.g., text) may be directly input into the multimodal model. A data segment of the second data modality (e.g., images, audio, etc.) may be segmented into a plurality of sub-segments. For example, a single image may be segmented into a plurality of sub-images of a same size, and a single audio segment may be segmented into a plurality of audio segments of a same length. Then, each sub-segment is input into the multimodal model separately. For example, pixel values of each sub-image and amplitudes in a spectrogram corresponding to each audio segment are input into the multimodal model.

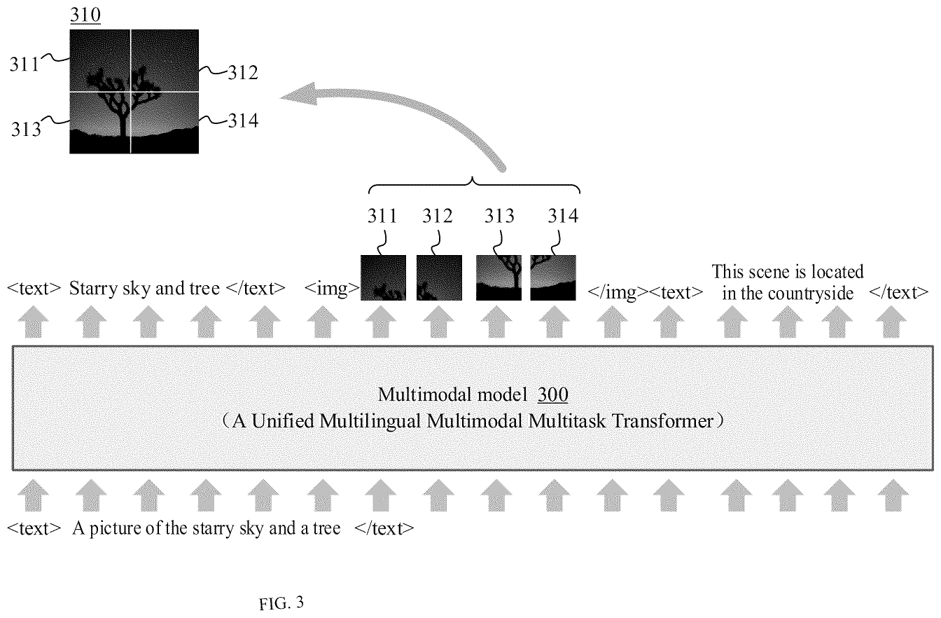

FIG. 3 is a schematic diagram of a multimodal data generation process implemented by using a multimodal model 300 according to an embodiment of the disclosure. The multimodal model 300 is a unified multilingual multimodal multitask transformer model that only includes a decoder in a transformer, and does not include an encoder.

As shown in FIG. 3, a query data sequence “<text>A picture of the starry sky and a tree</text>” is input into the multimodal model 300, and the multimodal model outputs a response data sequence “<text>Starry sky and tree</text><img>(Image token 311)(Image token 312)(Image token 313)(Image token 314)</img><text>This scene is located in the countryside</text>”, where the image tokens 311 to 314 form a generated result image 310.

In this embodiment of the disclosure, the multimodal model generates each token in the response data sequence in a semi-autoregressive manner. Specifically, the multimodal model integrates an autoregressive generation process for discrete data and a diffusion generation process for continuous data. For a discrete modality, i.e., the first data modality, tokens of the modality are generated one by one in a fully autoregressive manner (step S221). For a continuous modality, i.e., the second data modality, a plurality of tokens of the modality are generated based on diffusion as a whole (step S222).

According to some embodiments, the plurality of tokens output by the multimodal model include data content tokens and modality tags. Taking the response data sequence output by the multimodal model 300 in FIG. 3 as an example, in the response data sequence, “starry sky”, “and”, “tree”, “311”, “312”, “313”, “314”, “this scene”, “is located in”, and “the countryside” are data content tokens, and “<text>”, “</text>”, “<img>”, and “</img>” are modality tags.

In this embodiment of the disclosure, the multimodal model sequentially generates and outputs the plurality of tokens in the response data sequence. A current token is generated by the multimodal token based on a data modality of the current token.

According to some embodiments, the plurality of tokens output by the multimodal model include a modality tag pair. The modality tag pair includes a modality data start tag and a modality data end tag that indicate the same data modality. For example, <text> and </text> in FIG. 3 are respectively the modality data start tag and modality data end tag of a text modality, and <img> and </img> are respectively the modality data start tag and modality data end tag of an image modality.

According to some embodiments, corresponding to the multimodal model being able to output the modality tag pair, a data modality to which the current token belongs may be determined based on a last modality data start tag in the current response data sequence.

According to some embodiments, the modality data start tag and the modality data end tag are both tokens of the first data modality themselves, for example, are both tokens of the text modality. In response to determining that the current response data sequence is empty, it is determined that the current token belongs to the first data modality. Thus, the multimodal model can initiate the multimodal data generation process in an autoregressive manner and output the modality data start tag as a first token in the response data sequence.

According to some embodiments, when the current response data sequence is non-empty, in response to determining that the last modality data start tag in the current response data sequence indicates the first data modality, it is determined that the current token belongs to the first data modality. Further, step S221 is performed, where the query data sequence and the current response data sequence are input into the multimodal model, so that the multimodal model generates the current token in an autoregressive manner.

For example, in the embodiment shown in FIG. 3, when the current response data sequence is “<text>starry sky and”, and the last modality data start tag is <text>, it is determined that the current token belongs to a text modality, and the current token “tree” is generated in an autoregressive manner.

Alternatively, in response to determining that the last modality data start tag in the current response data sequence indicates the second data modality, it is determined that the current token belongs to the second data modality. Further, step S222 is executed, where the query data sequence, the current response data sequence, and an initial token sequence are input into the multimodal model, so that the multimodal model generates a preset quantity of tokens starting from the current token through diffusion generation, using the initial token sequence as a starting point.

For example, in the embodiment shown in FIG. 3, when the current response data sequence is “<text>starry sky and tree</text><img>”, and the last modality data start tag is <img>, it is determined that the current token (i.e., “311”) belongs to an image modality. The multimodal model generates four tokens starting from the current token “311”, i.e., a result token sequence [311, 312, 313, 314] through diffusion generation, using an initial token sequence including four random noise tokens as a starting point. The result token sequence represents a generated result image.

According to some embodiments, after generating the result token sequence, the multimodal model sequentially generates a modality data end tag indicating the second data modality (e.g., </img>), and a modality data start tag indicating the first data modality (e.g., <text>). This allows an autoregressive mode to be resumed after the result token sequence of the second data modality is generated, to generate subsequent tokens one by one.

According to some embodiments, in step S222, the multimodal model may perform a preset number of reverse diffusion operations (i.e., denoising operations) on the initial token sequence based on the query data sequence and the current response data sequence, to generate a result token sequence. Each reverse diffusion operation includes:
inputting the query data sequence, the current response data sequence, a current token sequence, and an identifier of a current reverse diffusion round into the multimodal model, so that the multimodal model generates a denoised token sequence.

A current token sequence for a first reverse diffusion operation is the initial token sequence. A current token sequence for a second and each subsequent reverse diffusion operations is a denoised token sequence generated by a previous reverse diffusion operation. A denoised token sequence generated by a last reverse diffusion operation is the result token sequence.

According to the above embodiments, by denoising the initial token sequence a plurality of times using a diffusion generation logic, a denoised clear result token sequence is finally generated, so that the data generation quality of the second data modality (such as images, audio) can be ensured.

According to some embodiments, the initial token sequence may be a random noise sequence. For example, a plurality of random noise tokens may be generated using a Gaussian distribution, thereby combining the plurality of random noise tokens, to obtain the initial token sequence.

In this embodiment of the disclosure, the initial token sequence includes a preset quantity of initial tokens. According to some embodiments, the preset quantity may be a preset fixed value, for example, 4, 6, etc.

According to some other embodiments, the preset quantity may also be a token of the first data modality that is output by the multimodal model, such as a parameter tag <token_num=N> of a text modality, where the value N of the modality parameter tag is the preset quantity. According to some embodiments, the preset quantity may be calculated based on the tokens of the first data modality output by the multimodal model. For example, the multimodal model outputs a parameter tag <img_size=W*H> of the text modality (referring to FIG. 3), which indicates sizes of an initial image and a generated result image. A data volume of pixel values of the initial image or the result image may be determined based on the parameter tag <img_size=W*H>. By dividing the data volume by a preset data volume of a single image token, a quantity of image tokens, i.e., the preset quantity described above, can be obtained.

According to some embodiments, the preset number of reverse diffusion operations may be a preset fixed value, for example, 50, 100, etc.

According to some other embodiments, the preset number may alternatively be a token of the first data modality that is output by the multimodal model, such as a parameter tag <diffusion=T> of the text modality, where the value T of the parameter tag is the preset number of reverse diffusion operations.

According to the above embodiments, the preset quantity of initial tokens included in the initial token sequence and the preset number of reverse diffusion operations may both be tokens output by the multimodal model, thereby enhancing the flexibility of data generation.

According to the embodiments of the disclosure, there is further provided a multimodal model training method. By performing the method, a trained multimodal model can be obtained. The trained multimodal model may be used to implement the multimodal data generation method 200 described above.

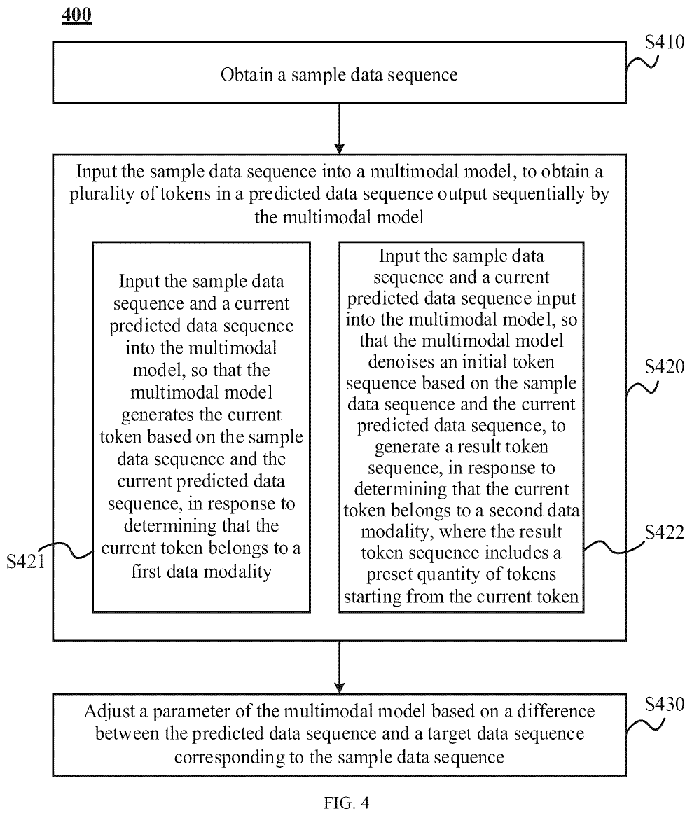

FIG. 4 is a flowchart of a multimodal model training method 400 according to an embodiment of the disclosure. An execution body of the method 400 is typically a server. In some embodiments, the execution body of the method 400 may alternatively be a client device. This usually requires the client device to have high hardware configurations and computing capabilities. As shown in FIG. 4, the method 400 includes steps S410 to S430.

In step S410, a sample data sequence is obtained. The sample data sequence includes at least one data segment, and each of the at least one data segment corresponds to one data modality.

In step S420, the sample data sequence is input into a multimodal model, to obtain a plurality of tokens in a predicted data sequence output sequentially by the multimodal model. A current token among the plurality of tokens is generated through the following step S421 or S422.

In step S421, the sample data sequence and a current predicted data sequence are input into the multimodal model, so that the multimodal model generates the current token based on the sample data sequence and the current predicted data sequence, in response to determining that the current token belongs to a first data modality. Values of unit data of the first data modality are discrete.

In step S422, the sample data sequence and a current predicted data sequence are input into the multimodal model, so that the multimodal model denoises an initial token sequence based on the sample data sequence and the current predicted data sequence, to generate a result token sequence, in response to determining that the current token belongs to a second data modality. Values of unit data of the second data modality are continuous. The initial token sequence includes a preset quantity of initial tokens, and the result token sequence includes the preset quantity of tokens starting from the current token.

In step S430, a parameter of the multimodal model is adjusted based on a difference between the predicted data sequence and a target data sequence corresponding to the sample data sequence.

According to the embodiments of the disclosure, a unified multimodal model is used to implement multimodal data generation. For a discrete modality such as natural language text, code, and protein sequences, the multimodal model sequentially generates each token of the modality in an autoregressive manner. For a continuous modality such as images and audio, the multimodal model performs diffusion generation by using a plurality of tokens of the modality as a whole.

The multimodal model in the embodiments of the disclosure integrates an autoregressive generation process for discrete data and a diffusion generation process for continuous data, so that the multimodal model has universal multimodal data understanding and generation capabilities, which improves the content generation effect and expands the capability range, thereby enabling the multimodal model to process diversified user tasks more flexibly and efficiently.

In this embodiment of the disclosure, the sample data sequence includes a modality tag pair. The modality tag pair includes a modality data start tag and a modality data end tag that indicate the same data modality, such as a text modality tag pair <text></text>, an image modality tag pair <img></img>, and an audio modality tag pair <audio></audio>. Each data segment in the sample data sequence corresponds to a data modality, which is identified by a modality data start tag set at the beginning of the data segment and a modality data end tag set at the end of the data segment.

In this embodiment of the disclosure, the sample data sequence may contain noise. The target data sequence corresponding to the sample data sequence is a denoised clear data sequence corresponding to the noisy sample data sequence. That is, the target data sequence is a generation target of the sample data sequence.

According to some embodiments, the sample data sequence may be generated through the following steps S401 to S403.

In step S401, a first data sequence is obtained.

In step S402, in response to the first data sequence including only a data segment of a first data modality (for example, the first data sequence is plain text), the first data sequence is directly used as a unimodal sample data sequence. Since no noise is added to the sample data sequence based on the first data sequence, the target data sequence corresponding to the sample data sequence is the sample data sequence itself.

In step S403, in response to the first data sequence including at least a first data segment of a second data modality (for example, if the first data sequence is unimodal data formed by images or multimodal data formed by text and images), a plurality of noise addition operations (i.e., forward diffusion) are performed on the first data segment, to obtain a plurality of second data segments corresponding to the plurality of noise addition operations respectively, thereby obtaining a plurality of second data sequences corresponding to the plurality of noise addition operations respectively. The noise addition operation may, for example, be adding random noise conforming to a Gaussian distribution. It can be understood that each second data sequence includes the corresponding second data segment. Each of the plurality of second data sequences may serve as a sample data sequence for training the multimodal model. In practice, one or more second data sequences may be randomly sampled from the plurality of second data sequences as the sample data sequence. The target data sequence corresponding to the sample data sequence is the first data sequence.

According to the above embodiment, the multimodal model processes unimodal data of discrete modalities such as text in a fully autoregressive manner without the need to perform noise addition operations. The generation target of the multimodal model is the same as the input. The multimodal model processes unimodal/multimodal data containing continuous modalities through diffusion generation, which needs to add noise to original data (i.e., the first data sequence). The input of the multimodal model is data after noise addition (i.e., the second data sequence), and the generation target of the model is clear original data.

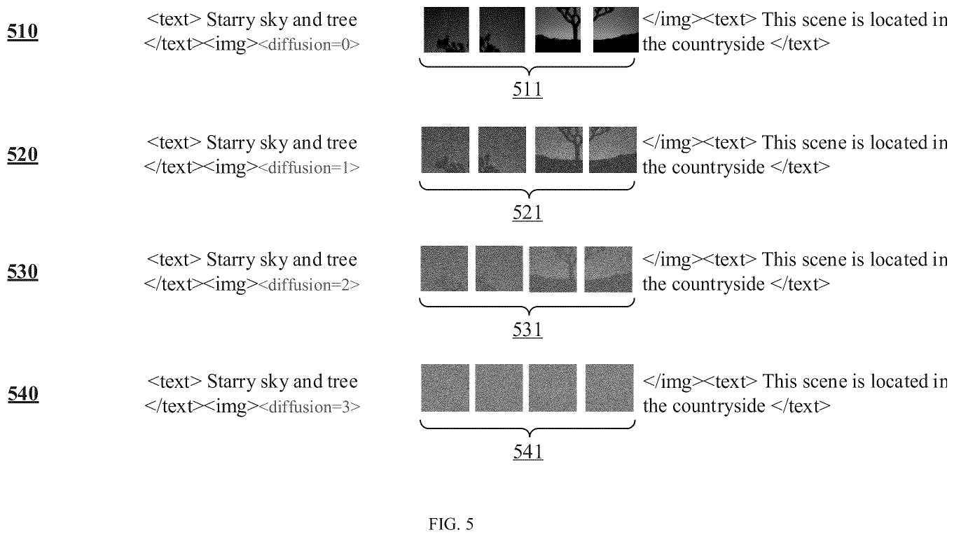

FIG. 5 is a schematic diagram of sample data sequences containing noise according to an embodiment of the disclosure. As shown in FIG. 5, a first data sequence 510 includes an image 511, i.e., a first data segment that includes a second data modality. The number of noise addition operations is identified by a <diffusion> tag. It should be noted that the image 511 is a clear image without noise.

As shown in FIG. 5, by adding noise to the image 511, a noisy image 521 is obtained, thereby obtaining a second data sequence 520.

By adding noise to the noisy image 521, a noisy image 531 is obtained, thereby obtaining a second data sequence 530.

By adding noise to the noisy image 531, a noisy image 541 is obtained, thereby obtaining a second data sequence 540.

The second data sequences 520 to 540 may all serve as a sample data sequence for training a multimodal model. A target data sequence corresponding to the sample data sequence is the first data sequence 510.

By inputting the sample data sequence 520, 530, or 540 into the multimodal model, the multimodal model generates and outputs a predicted data sequence in a semi-autoregressive manner. It is expected that the predicted data sequence is as identical as possible to the target data sequence 510.

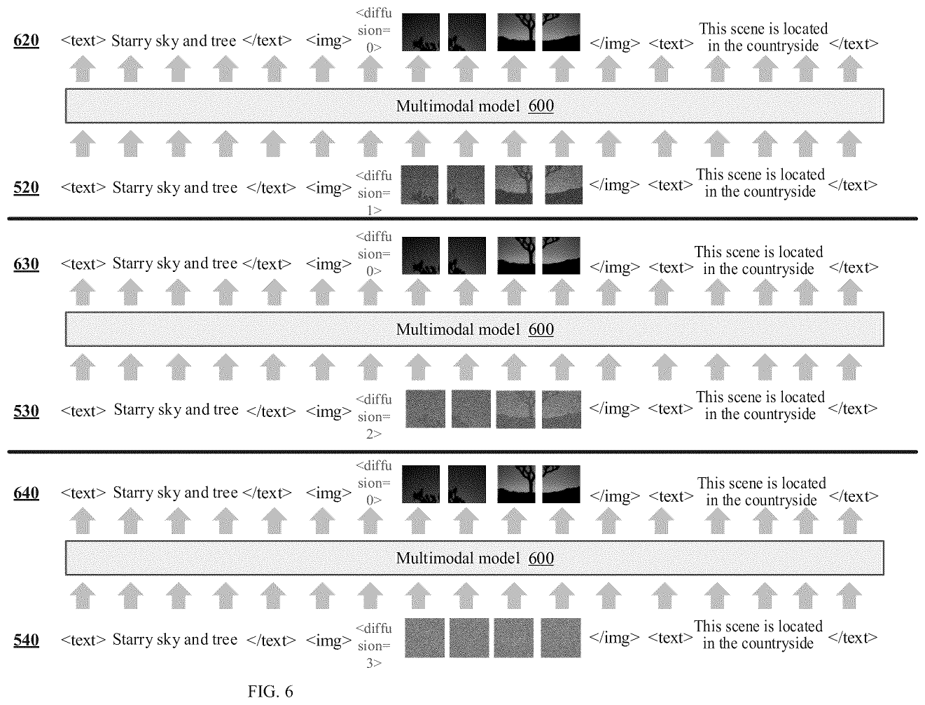

FIG. 6 is a schematic diagram of predicted data sequences 620, 630, and 640 output by a multimodal model 600 after inputting the sample data sequences 520, 530, and 540 into the multimodal model separately.

In this embodiment of the disclosure, the multimodal model generates tokens in the predicted data sequence in a semi-autoregressive manner. Specifically, the multimodal model integrates an autoregressive generation process for discrete data and a diffusion generation process for continuous data. For a discrete modality, i.e., the first data modality, tokens of the modality are generated one by one in a fully autoregressive manner (step S421). For a continuous modality, i.e., the second data modality, diffusion generation is performed by using a plurality of tokens of the modality as a whole (step S422).

According to some embodiments, the multimodal model is a Transformer model that only includes a decoder. According to this embodiment, the multimodal model adopts a Decoder-Only Transformer Decoder structure, and does not include an encoder.

According to the above embodiment, the query data sequence is directly input into the multimodal model with no need to be encoded, thereby enabling the multimodal model to directly process multimodal data, which enhances the efficiency and effect of multimodal knowledge fusion, and thus improves the multimodal data understanding and generation capabilities.

According to some embodiments, the decoder of the multimodal model includes an attention layer, and the semi-autoregressive data generation manner of the multimodal model may be implemented by controlling an attention mechanism adopted by the attention layer. Specifically, a mask may be used to control information of other tokens that need to be focused on when tokens in the predicted data sequence are generated. When the current token of the first data modality (e.g., a text modality) is generated, all tokens that have already been generated (i.e., all tokens in the current response sequence) are visible to the current token, and tokens that have not been generated are invisible to the current token, thereby enabling the model to focus only on historical information when generating the current token, instead of focusing on future information. When the current token of the second data modality (e.g., image modality) is generated, a plurality of tokens belonging to the modality, starting from the current token, are used as a whole token at a control level for attention calculation.

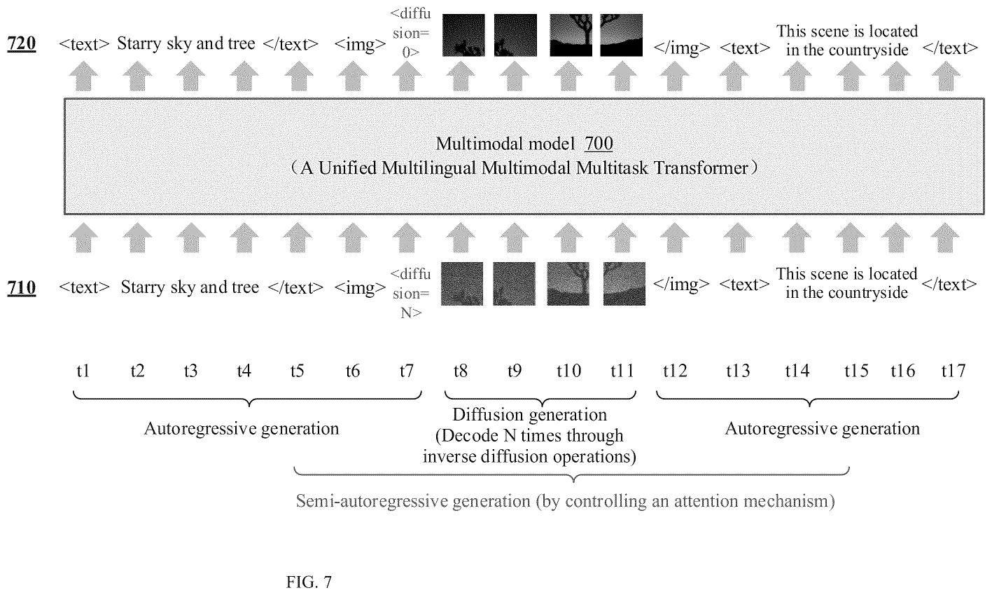

FIG. 7 is a schematic diagram of a training process of a multimodal model 700 according to an embodiment of the disclosure. The multimodal model 700 is a unified multilingual multimodal multitask transformer model that only includes a decoder in a transformer, and does not include an encoder.

As shown in FIG. 7, after inputting a sample data sequence 710 into the multimodal model 700, a predicted data sequence 720 is obtained as the output of the multimodal model 700. Tokens t1 to t7 and t12 to t17 of a text modality are generated in a fully autoregressive manner. Tokens t8 to t11 of an image modality are generated through a diffusion generation process. The autoregressive generation of the text modality and the diffusion generation of the image modality form a semi-autoregressive generation mechanism of the multimodal model 700. The semi-autoregressive generation mechanism is implemented by controlling an attention mechanism in a decoder of the multimodal model 700.

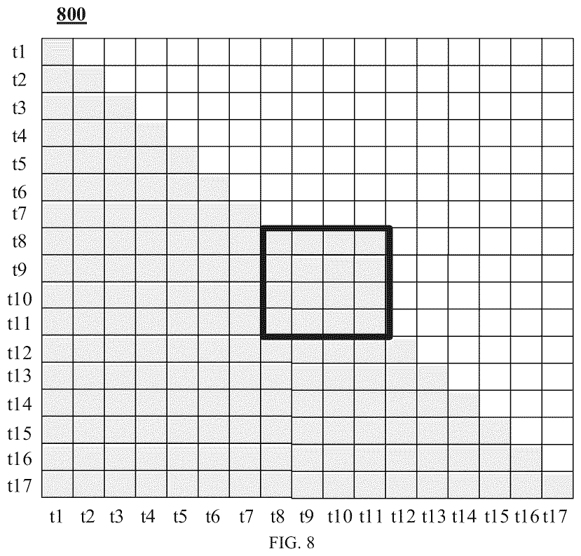

FIG. 8 is a schematic diagram of a mask matrix 800 used by the attention mechanism of the decoder. As shown in FIG. 8, the tokens t1 to t7 and t12 to t17 of the text modality are generated one by one, with each token being generated based on all tokens that have already been generated. For example, the token t6 is generated based on the already-generated tokens t1 to t5, and the token t16 is generated based on the already-generated tokens t1 to t15. The tokens t8 to t11 of the image modality are generated simultaneously as a whole token on a control level, as indicated by a black rectangular box in FIG. 8.

According to some embodiments, in step S422, the multimodal model may perform a preset number of reverse diffusion operations (i.e., denoising operations) on the initial token sequence based on the sample data sequence and the current predicted data sequence, to generate a result token sequence. Each reverse diffusion operation includes:
inputting the sample data sequence, the current predicted data sequence, a current token sequence, and an identifier of a current reverse diffusion round into the multimodal model, so that the multimodal model can generate a denoised token sequence.

A current token sequence for a first reverse diffusion operation is the initial token sequence. A current token sequence for a second and each subsequent reverse diffusion operations is a denoised token sequence generated by a previous reverse diffusion operation. A denoised token sequence generated by a last reverse diffusion operation is the result token sequence.

According to the above embodiments, by denoising the initial token sequence a plurality of times using a diffusion generation logic, a denoised clear result token sequence is finally generated, so that the data generation quality of the second data modality (such as images, audio) can be ensured.

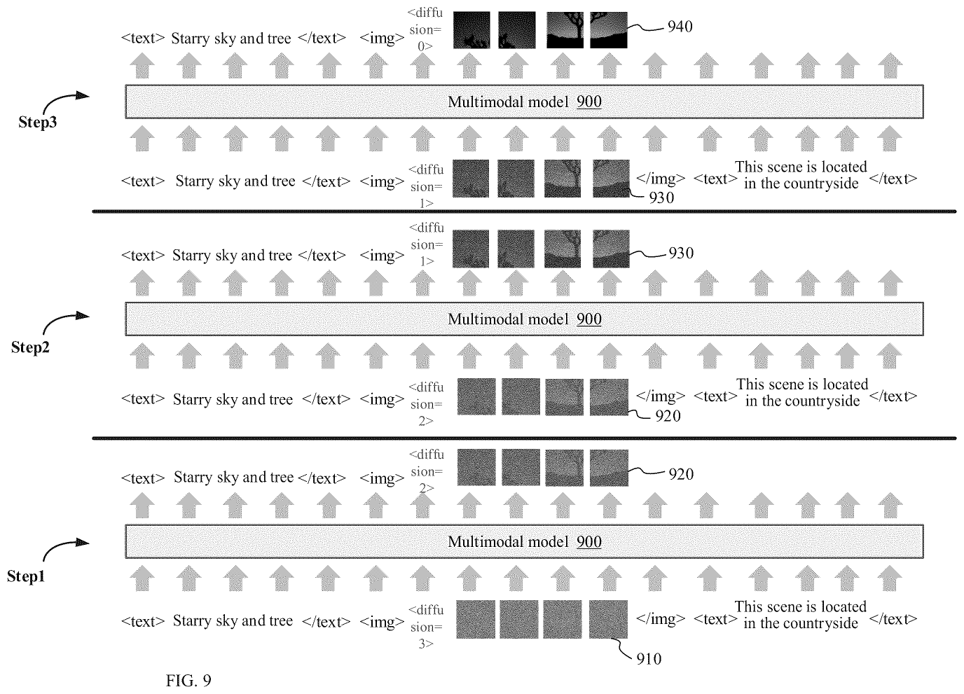

FIG. 9 is a schematic diagram of generating a result token sequence by a multimodal model through a plurality of reverse diffusion operations according to an embodiment of the disclosure. In the embodiment shown in FIG. 9, the multimodal model 900 generates a result token sequence 940 by performing three reverse diffusion operations on an initial token sequence 910.

Specifically, in Step 1, the multimodal model 900 performs the first reverse diffusion operation on the initial token sequence 910, with the identifier of the reverse diffusion round being 3, i.e., <diffusion=3>, to generate a denoised token sequence 920.

In Step 2, the multimodal model 900 further performs a reverse diffusion operation on the token sequence 920 that has been denoised once, with the identifier of the reverse diffusion round being 2, i.e., <diffusion=2>, to generate a token sequence 930 that has been denoised twice.

In Step 3, the multimodal model 900 further performs a reverse diffusion operation on the token sequence 930 that has been denoised twice, with the identifier of the reverse diffusion round being 1, i.e., <diffusion=1>, to generate a token sequence 940 that has been denoised three times, i.e., the result token sequence 940.

After the result token sequence 940 is obtained, the identifier of the reverse diffusion round is set to 0, i.e., <diffusion=0>.

It can be understood that in this embodiment of the disclosure, a parameter tag <diffusion=t> indicates a number of reverse diffusion operations to be performed. Each time the multimodal model performs a reverse diffusion operation, the value of t decreases by one. The parameter tag <diffusion=t> may be used to distinguish between a data understanding task and a data generation task. If t is a positive integer, it indicates that the multimodal model is performing a data generation task for the second data modality, such as generating an image. If t is 0, it indicates that the multimodal model has completed image generation and can next maintain <diffusion=0> as a condition to continue performing a data generation task for the first data modality or performing a data understanding task for the second data modality, such as image classification, image similarity determination, visual question answering, etc.

According to some embodiments, the initial token sequence may be obtained by segmenting the second data segment in the sample data sequence. For example, an image (i.e., the second data segment) in the sample data sequence may be segmented into a plurality of sub-images of the same size, and all pixel values within one sub-image may be used as one or more tokens, to obtain the initial token sequence. For example, referring to FIG. 7, the initial token sequence is a sequence composed of the tokens t8 to t11 at an input end of the model.

According to some embodiments, the sample data sequence includes at least two of the following:

1. A first sample data sequence that only includes a data segment of the first data modality. That is, the first sample data sequence is unimodal data of a discrete modality, such as plain text data.

2. A second sample data sequence that only includes a data segment of the second data modality. That is, the second sample data sequence is unimodal data of a continuous modality, such as images, audio, or other unimodal data.

3. A third sample data sequence that includes interleaved data segments of the first data modality and the second data modality. In other words, the third sample data sequence is interleaved multimodal data. For example, the third sample data sequence may be a text-image sequence, an image-text sequence, a text-image-text sequence, a text-audio sequence, etc.

According to the above embodiment, by performing multi-task joint training on the multimodal model by using sample data composed of different modalities, the model can fully learn both unimodal and cross-modal knowledge, thereby enhancing multimodal data understanding and generation capabilities of the model.

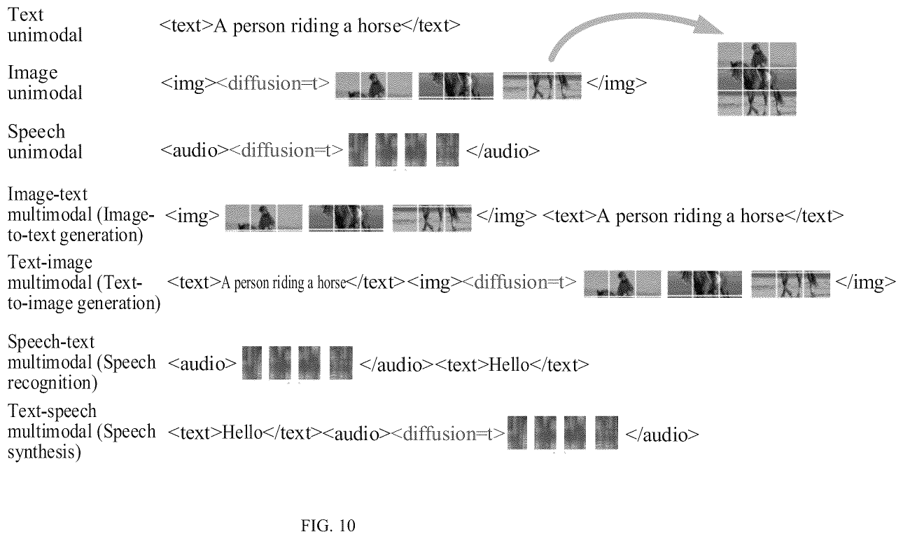

FIG. 10 is a schematic diagram of sample data sequences of different modalities according to some embodiments of the disclosure. The sample data sequences in FIG. 10 include unimodal data such as text, images, and speech, as well as interleaved multimodal data such as image-text, text-image, speech-text, and text-speech. The sample data sequences in this embodiment of the disclosure integrate different tasks of different modalities by using formal markup language as prompts, and perform sequential modeling in a unified manner to perform multi-task joint training on the multimodal model, so that the model can fully learn both unimodal and cross-modal knowledge, thereby improving multimodal data understanding and generation capabilities of the model.

It should be noted that the parameter tag <diffusion=t> in the sample data sequence in FIG. 10 represents the number of reverse diffusion operations to be performed.

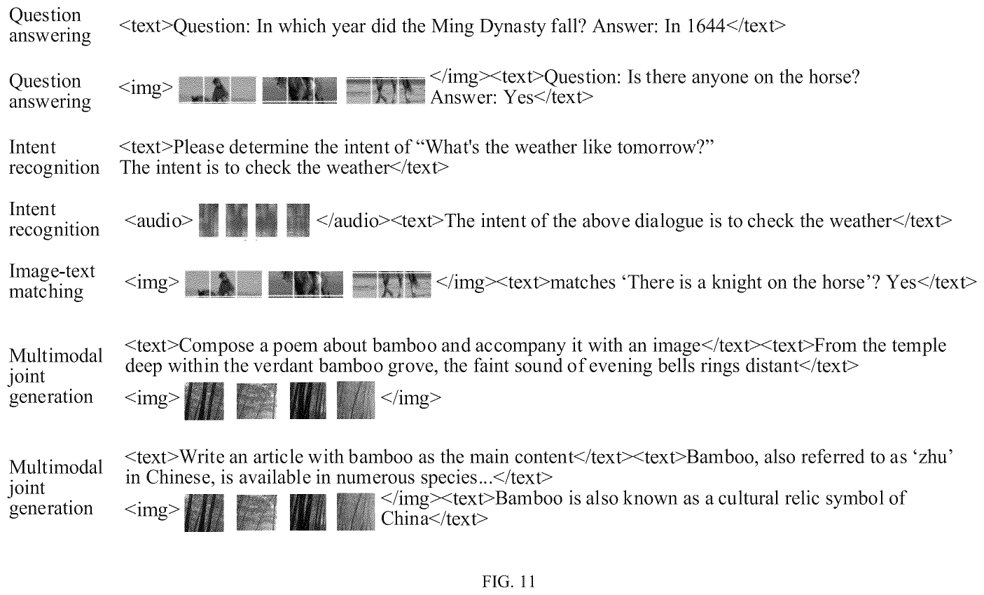

FIG. 11 is a schematic diagram of sample data sequences of different modalities and for different tasks according to some embodiments of the disclosure. The sample data sequences in FIG. 11 include unimodal data such as text, and multimodal data such as image-text, audio-text, text-text-image, and text-text-image-text. These sample data sequences may be used for modeling for processing specific tasks such as natural language question answering, intent recognition, image-text matching, and multimodal joint generation, thereby enabling the multimodal model to fully learn the knowledge in the specific tasks and improving the model's effect of processing specific multimodal data processing tasks.

It should be noted that the parameter tag <diffusion=t> is omitted in FIG. 11.

According to some embodiments, the multimodal model may be pre-trained by using the sample data sequences for different modalities in FIG. 10, in order to allow the multimodal model to fully learn unimodal and cross-modal knowledge, and to endow the multimodal model with universal multimodal data understanding and generation capabilities. On the basis of the multimodal model completing pre-training, sample data sequences of different modalities and for specific tasks shown in FIG. 11 may be used to further fine-tune the multimodal model, thereby improving the model's effect in processing specific multimodal data processing tasks.

According to some embodiments, the method 400 may alternatively be performed by a plurality of electronic devices. Any of the plurality of electronic devices is configured to train the multimodal model using sample data sequences of the same type. For example, each electronic device may be configured to train the multimodal model using any type of sample data sequence shown in FIG. 10 or FIG. 11. A loss value of the multimodal model is a sum of respective local loss values of the plurality of electronic devices. In this embodiment, distributed training of the multimodal model in a data-parallel manner can improve training efficiency.

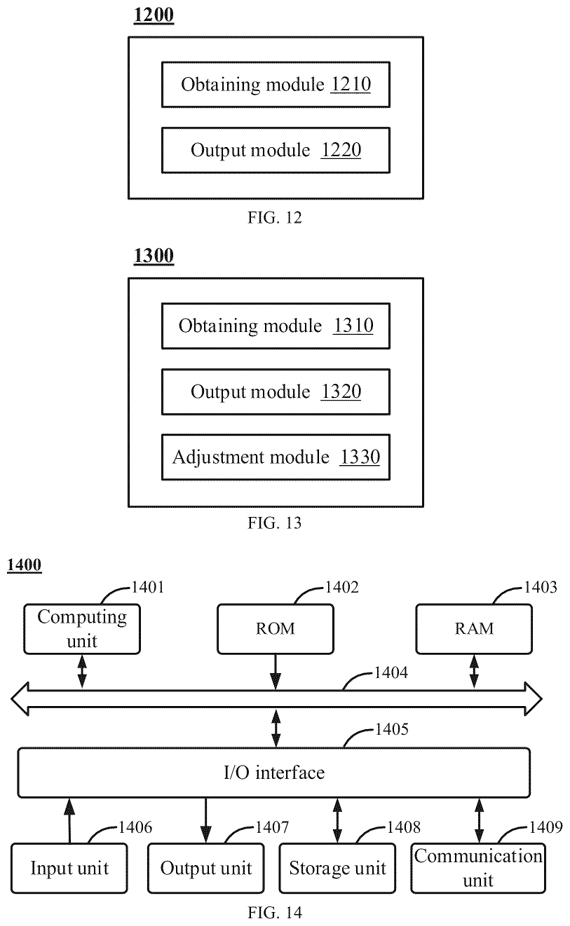

According to the embodiments of the disclosure, there is further provided a multimodal data generation apparatus. FIG. 12 is a block diagram of a structure of the multimodal data generation apparatus 1200 according to an embodiment of the disclosure. As shown in FIG. 12, the apparatus 1200 includes an obtaining module 1210 and an output module 1220.

The obtaining module 1210 is configured to obtain a query data sequence, where the query data sequence includes at least one data segment, and each of the at least one data segment corresponds to one data modality.

The output module 1220 is configured to input the query data sequence into a multimodal model, to obtain a plurality of tokens in a response data sequence output sequentially by the multimodal model, where a current token among the plurality of tokens is generated through the following operations:
inputting the query data sequence and a current response data sequence into the multimodal model, so that the multimodal model generates the current token based on the query data sequence and the current response data sequence, in response to determining that the current token belongs to a first data modality, where values of unit data of the first data modality are discrete; or
inputting the query data sequence and a current response data sequence into the multimodal model, so that the multimodal model denoises an initial token sequence based on the query data sequence and the current response data sequence, to generate a result token sequence, in response to determining that the current token belongs to a second data modality, where values of unit data of the second data modality are continuous, the initial token sequence includes a preset quantity of initial tokens, and the result token sequence includes the preset quantity of tokens starting from the current token.

According to the embodiments of the disclosure, a unified multimodal model is used to implement multimodal data generation. For a discrete modality such as natural language text, code, and protein sequences, the multimodal model sequentially generates each token of the modality in an autoregressive manner. For a continuous modality such as images and audio, the multimodal model performs diffusion generation by using a plurality of tokens of the modality as a whole.

The multimodal model in the embodiments of the disclosure integrates an autoregressive generation process for discrete data and a diffusion generation process for continuous data, so that the multimodal model has universal multimodal data understanding and generation capabilities, which improves the content generation effect and expands the capability range, thereby enabling the multimodal model to process diversified user tasks more flexibly and efficiently.

It should be understood that the various modules and units of the apparatus 1200 shown in FIG. 12 may correspond to the steps in the method 200 described in FIG. 2. Therefore, the operations, features, and advantages described above for the method 200 are also applicable to the apparatus 1200 and the modules and units included therein. For the sake of brevity, some operations, features, and advantages are not described herein again.

According to an embodiment of the disclosure, there is further provided a multimodal model training apparatus. FIG. 13 is a block diagram of a structure of the multimodal model training apparatus 1300 according to an embodiment of the disclosure. As shown in FIG. 13, the apparatus 1300 includes an obtaining module 1310, an output module 1320, and an adjustment module 1330.

The obtaining module 1310 is configured to obtain a sample data sequence, where the sample data sequence includes at least one data segment, and each of the at least one data segment corresponds to one data modality.

The output module 1320 is configured to input the sample data sequence into the multimodal model, to obtain a plurality of tokens in a predicted data sequence output sequentially by the multimodal model, where a current token among the plurality of tokens is generated through the following operations:
inputting the sample data sequence and a current predicted data sequence into the multimodal model, so that the multimodal model generates the current token based on the sample data sequence and the current predicted data sequence, in response to determining that the current token belongs to a first data modality, where values of unit data of the first data modality are discrete; or
inputting the sample data sequence and a current predicted data sequence into the multimodal model, so that the multimodal model denoises an initial token sequence based on the sample data sequence and the current predicted data sequence, to generate a result token sequence, in response to determining that the current token belongs to a second data modality, where values of unit data of the second data modality are continuous, the initial token sequence includes a preset quantity of initial tokens, and the result token sequence includes the preset quantity of tokens starting from the current token.

The adjustment module 1330 is configured to adjust a parameter of the multimodal model based on a difference between the predicted data sequence and a target data sequence corresponding to the sample data sequence.

According to the embodiments of the disclosure, a unified multimodal model is used to implement multimodal data generation. For a discrete modality such as natural language text, code, and protein sequences, the multimodal model sequentially generates each token of the modality in an autoregressive manner. For a continuous modality such as images and audio, the multimodal model performs diffusion generation by using a plurality of tokens of the modality as a whole.

The multimodal model in the embodiments of the disclosure integrates an autoregressive generation process for discrete data and a diffusion generation process for continuous data, so that the multimodal model has universal multimodal data understanding and generation capabilities, which improves the content generation effect and expands the capability range, thereby enabling the multimodal model to process diversified user tasks more flexibly and efficiently.

It should be understood that the various modules and units of the apparatus 1300 shown in FIG. 13 may correspond to the steps in the method 400 described in FIG. 4. Therefore, the operations, features, and advantages described above for the method 400 are also applicable to the apparatus 1300 and the modules and units included therein. For the sake of brevity, some operations, features, and advantages are not described herein again.

Although specific functions are discussed above with reference to specific modules, it should be noted that the functions of the various modules discussed herein may be divided into a plurality of modules, and/or at least some functions of a plurality of modules may be combined into a single module.

It should be further understood that, various technologies may be described herein in the general context of software and hardware elements or program modules. The above units described with reference to FIG. 12 and FIG. 13 may be implemented in hardware or hardware combined with software and/or firmware. For example, these units may be implemented as computer program code/instructions configured to be executed in one or more processors and stored in a computer-readable storage medium. Alternatively, these units may be implemented as hardware logic/circuitry. For example, in some embodiments, one or more of the modules 1210 to 1220 and 1310 to 1330 may be implemented together in a system on chip (SoC). The SoC may include an integrated circuit chip (which includes a processor (e.g., a central processing unit (CPU), a microcontroller, a microprocessor, and a digital signal processor (DSP)), a memory, one or more communication interfaces, and/or one or more components in other circuits), and may optionally execute a received program code and/or include an embedded firmware to perform functions.

According to an embodiment of the disclosure, there is further provided an electronic device, including: at least one processor; a memory communicatively connected to the at least one processor, where the memory stores instructions that can be executed by the at least one processor, and the instructions, when executed by the at least one processor, cause the at least one processor to perform the multimodal data generation method and/or the multimodal model training method according to the embodiments of the disclosure.

According to an embodiment of the disclosure, there is further provided a non-transitory computer-readable storage medium storing computer instructions, where the computer instructions are used to cause a computer to perform the multimodal data generation method and/or the multimodal model training method according to the embodiments of the disclosure.

According to an embodiment of the disclosure, there is further provided a computer program product. The computer program product includes computer program instructions, where the computer program instructions, when executed by a processor, cause the multimodal data generation method and/or the multimodal model training method according to the embodiments of the disclosure to be implemented.

Referring to FIG. 14, a block diagram of a structure of an electronic device 1400 that can serve as a server or a client of the disclosure is now described. The electronic device is an example of a hardware device that can be applied to various aspects of the disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the disclosure described and/or required herein.

As shown in FIG. 14, the electronic device 1400 includes a computing unit 1401. The computing unit may perform various appropriate actions and processing according to a computer program stored in a read-only memory (ROM) 1402 or a computer program loaded from a storage unit 1408 to a random access memory (RAM) 1403. The RAM 1403 may further store various programs and data required for the operation of the electronic device 1400. The computing unit 1401, the ROM 1402, and the RAM 1403 are connected to each other through a bus 1404. An input/output (I/O) interface 1405 is also connected to the bus 1404.

A plurality of components in the electronic device 1400 are connected to the I/O interface 1405, including: an input unit 1406, an output unit 1407, the storage unit 1408, and a communication unit 1409. The input unit 1406 may be any type of device capable of entering information to the electronic device 1400. The input unit 1406 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 1407 may be any type of device capable of presenting information, and may include, but is not limited to, a display, a speaker, a video/audio output terminal, a vibrator, and/or a printer. The storage unit 1408 may include, but is not limited to, a magnetic disk and an optical disk. The communication unit 1409 allows the electronic device 1400 to exchange information/data with other devices through a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMAX device, or a cellular communication device.

The computing unit 1401 may be various general-purpose and/or special-purpose processing components with processing and computing capabilities. Some examples of the computing unit 1401 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1401 performs the various methods and processing described above, for example, the method 200 or 400. For example, in some embodiments, the method 200 and the method 400 may be implemented as a computer software program, which is tangibly contained in a machine-readable medium, such as the storage unit 1408. In some embodiments, a part or all of the computer program may be loaded and/or installed onto the electronic device 1400 via the ROM 1402 and/or the communication unit 1409. When the computer program is loaded to the RAM 1403 and executed by the computing unit 1401, one or more steps of the method 200 and the method 400 described above can be performed. Alternatively, in other embodiments, the computing unit 1401 may be configured, by any other suitable means (for example, by means of firmware), to perform the method 200 or 400.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses may also be used to provide interaction with the user; for example, feedback provided to the user may be any form of sensory feedback (for example, visual feedback, auditory feedback, or tactile feedback); and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system may be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the disclosure may be performed in parallel, in order, or in a different order, provided that the desired result of the technical solutions disclosed in the disclosure can be achieved, which is not limited herein.

Although the embodiments or examples of the disclosure have been described with reference to the drawings, it should be understood that the methods, systems and devices described above are merely example embodiments or examples, and the scope of the disclosure is not limited by the embodiments or examples, and is only defined by the scope of the granted claims and the equivalents thereof. Various elements in the embodiments or examples may be omitted or substituted by equivalent elements thereof. Moreover, the steps may be performed in an order different from that described in the disclosure. Further, various elements in the embodiments or examples may be combined in various ways. It is important that, as the technology evolves, many elements described herein may be replaced with equivalent elements that appear after the disclosure.

What is claimed is:

1. A multimodal data generation method, comprising:
obtaining a query data sequence, wherein the query data sequence comprises at least one data segment, and wherein each data segment of the at least one data segment corresponds to one data modality; and
inputting the query data sequence into a multimodal model, to obtain a plurality of tokens in a response data sequence output sequentially by the multimodal model, wherein a current token among the plurality of tokens is generated through the following operations:
in response to determining that the current token belongs to a first data modality, inputting the query data sequence and a current response data sequence into the multimodal model, so that the multimodal model generates the current token based on the query data sequence and the current response data sequence, wherein values of unit data of the first data modality are discrete; or
in response to determining that the current token belongs to a second data modality, inputting the query data sequence and the current response data sequence into the multimodal model, so that the multimodal model denoises an initial token sequence based on the query data sequence and the current response data sequence, to generate a result token sequence, wherein values of unit data of the second data modality are continuous, wherein the initial token sequence comprises a preset quantity of initial tokens, and wherein the result token sequence comprises the preset quantity of tokens starting from the current token.

2. The method according to claim 1, wherein the plurality of tokens comprise a modality tag pair, the modality tag pair comprising a modality data start tag and a modality data end tag that indicate a same data modality, and there being at least one token belonging to a corresponding data modality between the modality data start tag and the modality data end tag, and the method further comprises:
determining a data modality to which the current token belongs based on a last modality data start tag in the current response data sequence.

3. The method according to claim 2, wherein the determining a data modality to which the current token belongs based on a last modality data start tag in the current response data sequence comprises:
in response to determining that the last modality data start tag in the current response data sequence indicates the first data modality, determining that the current token belongs to the first data modality; or
in response to determining that the last modality data start tag in the current response data sequence indicates the second data modality, determining that the current token belongs to the second data modality.

4. The method according to claim 3, further comprising:
after that the result token sequence is generated, sequentially generating a modality data end tag indicating the second data modality, and a modality data start tag indicating the first data modality.

5. The method according to claim 2, wherein the modality data start tag and the modality data end tag are both tokens of the first data modality, and the method further comprises:
in response to determining that the current response data sequence is empty, determining that the current token belongs to the first data modality.

6. The method according to claim 1, wherein the denoising, through the multimodal model, an initial token sequence based on the query data sequence and the current response data sequence, to generate a result token sequence comprises:
performing, through the multimodal model, a preset number of reverse diffusion operations on the initial token sequence based on the query data sequence and the current response data sequence, to generate the result token sequence, wherein each reverse diffusion operation comprises:
inputting the query data sequence, the current response data sequence, a current token sequence, and an identifier of a current reverse diffusion round into the multimodal model, so that the multimodal model generates a denoised token sequence,
wherein a current token sequence for a first reverse diffusion operation is the initial token sequence, a current token sequence for a second and each subsequent reverse diffusion operation is a denoised token sequence generated by a previous reverse diffusion operation, and a denoised token sequence generated by a last reverse diffusion operation is the result token sequence.

7. The method according to claim 6, wherein the preset quantity is a token of the first data modality that is output by the multimodal model.

8. The method according to claim 6, wherein the preset number is a token of the first data modality that is output by the multimodal model.

9. The method according to claim 6, wherein the preset quantity and the preset number are both tokens of the first data modality that are output by the multimodal model.

10. The method according to claim 1, further comprising:
obtaining an initial query data sequence entered by a user, wherein the initial query data sequence comprises at least one initial data segment, and wherein each initial data segment of the at least one initial data segment corresponds to one data modality; and
adding, for each initial data segment of the at least one initial data segment, a modality data start tag indicating a data modality of the initial data segment before the initial data segment, and adding a modality data end tag indicating a data modality of the initial data segment after the initial data segment, to obtain the query data sequence.

11. The method according to claim 1, wherein the multimodal model is a transformer model that comprises only a decoder.

12. The method according to claim 1, wherein the first data modality comprises any one of the following: natural language text, tables, code, SMILES molecular formulas, or protein sequences; and
the second data modality comprises any one of the following: images, videos, audio, or point cloud data.

13. The method according to claim 1, wherein the initial token sequence is a random noise sequence.

14. A multimodal model training method, comprising:
obtaining a sample data sequence, wherein the sample data sequence comprises at least one data segment, and wherein each data segment of the at least one data segment corresponds to one data modality;
inputting the sample data sequence into a multimodal model, to obtain a plurality of tokens in a predicted data sequence output sequentially by the multimodal model, wherein a current token among the plurality of tokens is generated through the following steps:
in response to determining that the current token belongs to a first data modality, inputting the sample data sequence and a current predicted data sequence into the multimodal model, so that the multimodal model generates the current token based on the sample data sequence and the current predicted data sequence, wherein values of unit data of the first data modality are discrete; or
in response to determining that the current token belongs to a second data modality, inputting the sample data sequence and the current predicted data sequence into the multimodal model, so that the multimodal model denoises an initial token sequence based on the sample data sequence and the current predicted data sequence, to generate a result token sequence, wherein values of unit data of the second data modality are continuous, wherein the initial token sequence comprises a preset quantity of initial tokens, and wherein the result token sequence comprises the preset quantity of tokens starting from the current token;
and
adjusting a parameter of the multimodal model based on a difference between the predicted data sequence and a target data sequence corresponding to the sample data sequence.

15. The method according to claim 14, wherein the sample data sequence comprises at least two of the following:
a first sample data sequence that only comprises a data segment of the first data modality;
a second sample data sequence that only comprises a data segment of the second data modality, or
a third sample data sequence that comprises interleaved data segments of the first data modality and the second data modality.

16. The method according to claim 15, wherein the method is performed by a plurality of electronic devices, any one of the plurality of electronic devices is configured to train the multimodal model by using sample data sequences of a same type, and a loss value of the multimodal model is a sum of respective local loss values of the plurality of electronic devices.

17. The method according to claim 14, wherein the sample data sequence only comprises a data segment of the first data modality, and wherein, the target data sequence is the sample data sequence itself.

18. The method according to claim 14, wherein the sample data sequence comprises at least a data segment of the second data modality, and the method further comprises:
obtaining a first data sequence, wherein the first data sequence comprises at least a first data segment of the second data modality;
performing a plurality of noise addition operations on the first data segment, to obtain a plurality of second data segments corresponding to the plurality of noise addition operations respectively, thereby obtaining a plurality of second data sequences corresponding to the plurality of noise addition operations respectively,
wherein the sample data sequence is any one of the plurality of second data sequences, and the target data sequence is the first data sequence.

19. The method according to claim 18, wherein the initial token sequence is obtained by segmenting a second data segment in the sample data sequence.

20. An electronic device, comprising:
one or more processors;
a memory storing one or more programs configured to be executed by the one or more processors, the one or more programs including instructions for:
obtaining a query data sequence, wherein the query data sequence comprises at least one data segment, and each of the at least one data segment corresponds to one data modality; and
inputting the query data sequence into a multimodal model, to obtain a plurality of tokens in a response data sequence output sequentially by the multimodal model, wherein a current token among the plurality of tokens is generated through the following operations:
in response to determining that the current token belongs to a first data modality, inputting the query data sequence and a current response data sequence into the multimodal model, so that the multimodal model generates the current token based on the query data sequence and the current response data sequence, wherein values of unit data of the first data modality are discrete; or
in response to determining that the current token belongs to a second data modality, inputting the query data sequence and the current response data sequence into the multimodal model, so that the multimodal model denoises an initial token sequence based on the query data sequence and the current response data sequence, to generate a result token sequence, wherein values of unit data of the second data modality are continuous, wherein the initial token sequence comprises a preset quantity of initial tokens, and wherein the result token sequence comprises the preset quantity of tokens starting from the current token.
